(19) United States
(12) Patent Application Publication
(10) Pub. No.: US 2025/0202869 A1
(43) Pub. Date: Jun. 19, 2025

(54) OFFLINE MULTI-FACTOR AUTHENTICATION

(71) Applicant: JumpCloud, Inc., Louisville, CO (US)

(72) Inventors: Joel Rennich, West Lakeland, MN (US); Jared Cantwell, Boulder, CO (US)

(21) Appl. No.: 18/545,964

(22) Filed: Dec. 19, 2023

(51) Int. Cl. H04L 9/40; H04L 9/08; H04L 9/30; H04L 9/32; H04W 12/63

(52) U.S. Cl. CPC H04L 63/0428; H04L 9/085; H04L 9/30; H04L 9/32; H04W 12/63

(57) ABSTRACT

Mechanisms for resource management are described. A public key of a second device and an identifier of the public key may be received at a first device. The public key may correspond to a private key stored at the second device, be referenceable using the key identifier, and be associated with a user. A string of randomized characters may be encrypted at the first device using a secret generated from an ephemeral key generated at the first device and the public key, and encrypted data may be obtained. A packet may be generated at the first device that includes the ephemeral key, the key identifier, and the encrypted data. Based on providing the packet to the second device, the string of randomized characters may be inputted into the first device and the user may be authenticated for access to the first device.

### TECHNICAL FIELD

The present disclosure relates generally to resource management, including techniques for offline multi-factor authentication.

### BACKGROUND

An organization (e.g., a company, enterprise, etc.) may manage, operate, and/or have access to numerous remote and local servers as part of its information technology (IT) system. The servers in the IT system may be used for hosting, storing, and distributing software applications, business documents, entertainment files (e.g., audio and video files), webpages, and the like. The servers in the IT system may located on premises, located off premises (e.g., within remote data centers), hosted by a third-party (e.g., in “the cloud”). The organization may also manage, operate, and/or have access to numerous remote and local devices as part of its IT system. The devices (e.g., computers, phones, tablets, printers, etc.) in the IT system may be used to run applications, access aspects of the IT system, and serve other productivity functions. As new devices and servers are brought online and old devices and servers are decommissioned, IT systems tend to be constantly changing, and, as a result, managing IT systems may be time consuming, labor intensive, and tedious.

Resource management systems may facilitate the management of, operation of, and access to a wide variety of system resources (including local servers, remote servers, cloud-based servers, etc.) in an IT system. Resource management systems may also facilitate the management of, operation of, and access to user resources, including physical user devices (e.g., laptops, desktops, phones, tablets, etc.) and virtual user devices (e.g., virtual machines). User resources may be under the control of a user that is in possession of the user resource. In some examples, a user resource may be owned by the user, and software associated with the organization (e.g., mobile device management (MDM) software) may be used to manage operations aspects of the user resource. Accordingly, user resources may be scattered throughout a geographic environment. For example, certain user resources may be located within an internal IT network, while other user resources may be located outside an internal IT network. Also, positions of user resources may be constantly (relative to system resources) changing. For example, certain user resources may constantly (e.g., on a daily basis) join and leave an internal IT network. In some examples, user resources that are outside an internal IT network may gain access to the internal IT network using a virtual public network service.

Managing and supporting the operation of user resources may include installing software on user resources, setting system-level configurations (e.g., password requirements, default permissions, etc.) for user resources, controlling access of users to particular software and user services, controlling access of users to user resources, internal resources, third-party software and third-party services, and the like. Centralized and consistent application of IT policy across system resources, user resources, and users is imperative to achieving an IT system that functions efficiently and predictably.

### BRIEF DESCRIPTION OF THE DRAWINGS

FIG. 1 shows an example of a computing environment that supports offline multi-factor authentication in accordance with examples disclosed herein.

FIG. 2 shows an example of a subsystem that supports offline multi-factor authentication in accordance with examples disclosed herein.

FIG. 3 shows an example of a set of operations for offline multi-factor authentication in accordance with examples disclosed herein.

FIG. 4 shows an example of a device that supports offline multi-factor authentication in accordance with examples disclosed herein.

FIG. 5 shows an example of a resource management component that supports offline multi-factor authentication in accordance with examples disclosed herein.

FIG. 6 shows an example of a device that supports offline multi-factor authentication in accordance with examples disclosed herein.

FIGS. 7 and 8 show examples of sets of operations for offline multi-factor authentication in accordance with examples disclosed herein.

### DETAILED DESCRIPTION

A device may require a user to provide multiple factors of authentication before providing a user access to the device. In some examples, external (e.g., web-based, phone-based, etc.) entities (e.g., a resource management system) may be used to provide one or more secondary factors of authentication (e.g., a push notification). However, a device may not always have a connection to the external service (e.g., if the device is offline, if the authenticating device is offline, if the external entity is offline, etc.).

In some examples, a device may use time-based one-time password (TOTP) codes to generate a secondary factor of authentication, where the device and the authenticating device may be configured to generate a same set of randomized TOTP codes from a same secret (which may be referred to as a “TOTP seed”) that is shared between the devices. In such cases, a user may obtain a TOTP code from the authenticating device and input the TOTP code into the device, which may verify that the TOTP code obtained from the authenticating device matches the TOTP code individually generated at the device prior to granting the user access to the device.

However, TOTP codes, among other issues, may have security vulnerabilities (e.g., if a bad actor obtains the TOTP seed, if the bad actor can generate the same TOTP codes as the push application) and reliability issues (e.g., time drift between devices may cause the TOTP codes generated at corresponding devices to diverge). Thus, mechanisms for generating offline secondary factors of authentication with improved security (e.g., that do not expose/share a secret) and reliability may be desired.

To generate offline secondary factors of authentication with improved security and reliability, a public key generated at a secondary device and an ephemeral key generated at an endpoint device may be used to obtain an encrypted string of randomized characters that is provided to the secondary device, which may decrypt and display the string of randomized characters to the user for entry into the endpoint device.

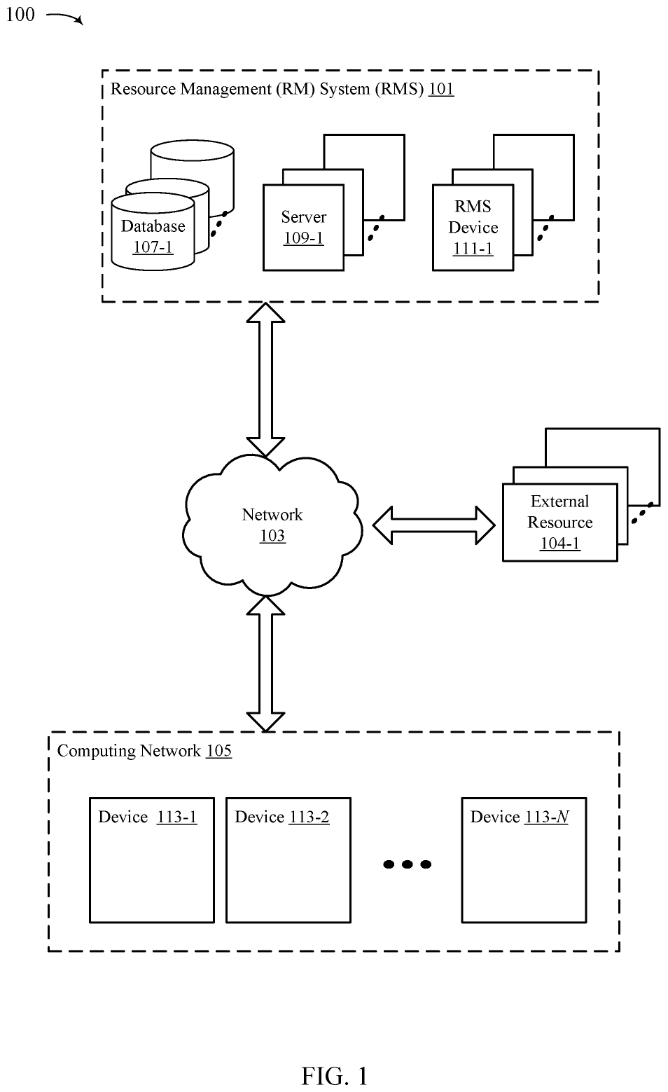

FIG. 1 shows an example of a computing environment that supports offline multi-factor authentication in accordance with examples disclosed herein.

The computing environment 100 may include a resource management system (RMS), such as the RMS 101, the network 103, one or more external, third-party resources (e.g., the first external resource 104-1), and one or more computing networks (e.g., the computing network 105).

The RMS 101 may be configured to manage and support the operation of the computing network 105. For example, the RMS 101 may be configured to implement an information technology (IT) policy across one or more resources (e.g., the devices 113) within the computing network 105. The RMS 101 may also be configured to implement and apply IT policy for users of the computing network 105—e.g., the RMS 101 may govern access of users to particular resources, to particular information (e.g., network drives, folders, files, etc.), particular resources (e.g., internal resources, external resources, internal services, external services, etc.), and the like. In some examples, the RMS 101 may provide a centralized location for adding, modifying, or deleting resources, resource configurations, resource permissions, users, user information, user permissions, and the like. In some examples, the RMS 101 may be configured to store resource and user information, such as resource identity, an Internet Protocol (IP) address of a resource, authentication information of a user, a personal information of a user, and the like.

The RMS 101 may include one or more databases (e.g., the first database 107-1), one or more servers (e.g., the first server 109-1), one or more RMS resources (e.g., the first RMS resource 111-1), or any combination thereof, which may be used to support (e.g., implement, provide storage for, etc.) the services offered by the RMS 101. The one or more RMS resources may be implemented as physical machines, containers, or virtual machines. In some examples, the one or more databases are implemented using one or more servers, one or more RMS resources, or a combination thereof.

The network 103 may include both private, public, and shared networking infrastructure. For example, the network 103 may include portions of networking infrastructure included within the computing network 105, portions of networking infrastructure included within the RMS 101, or both. Also, the network 103 may include network infrastructure external to both the RMS 101 and the computing network 105 that may be operated by external operators (e.g., Internet service providers (ISPs), cellular providers, satellite providers, etc.) and is used to connect resources together (e.g., digital subscriber line (DSL) networks, cable networks, fiber optic networks, cellular networks, satellite networks, etc.).

The computing network 105 may include one or more resources (e.g., the first device 113-1 through the Nth device 113-N) as well as networking infrastructure to connect the one or more resources to one another, to external networks, and the like. The devices 113 may include system-level devices (e.g., servers, databases, etc.) and user devices (e.g., laptops, desktops, phones, tablets, virtual machines, etc.). In some examples, the system-level devices of the computing network may be located on a premises of, or otherwise under the control of, an operator of the computing network 105. The user devices may be on-premises, off-premises, or may transition between being on and off-premises. For example, a laptop may be brought on premises during business hours and taken off premises outside of business hours. In another example, a laptop may be located primarily off-premises (e.g., if used for remote work). The system-level and user devices may be physical machines or virtual machines.

The external resources (e.g., the first external resource 104-1) may include virtual machines, websites, databases, file servers, web-based applications, web-based services, web-based computing resources, and the like. For example, the external resources may include Salesforce, Microsoft 365, Google Drive, Zoom, Microsoft Azure, and the like. In some examples, the external resources may be implemented using infrastructure that is separate from the infrastructure of the RMS 101, the infrastructure of the computing network 105, or both. In some examples, the infrastructure used to implement the external resources is managed by a different party than the party that controls the RMS 101. In some examples, the infrastructure used to implement the external resources is managed by a different party than the party that controls the computing network 105.

A device (e.g., the first device 113-1) may require a user to provide multiple factors of authentication before granting the user access to the device—e.g., to provide enhanced security for the device against malicious actors that have obtained a user's username and password. The multiple factors of authentication may include two or more of a username and password, a time-based one-time password (TOTP), a push challenge, a short message service (SMS) challenge, a telephone challenge, a biometric challenge, and the like.

The RMS 101 may be used to provide a second factor of authentication used to grant a user access to a device (e.g., the first device 113-1). In some examples, the RMS 101 may be used to support a push service that sends a time-based notification to a separate device (e.g., the second device 113-2, a mobile device) that is under the control of the user. The RMS 101 may verify the second factor of authentication when the user acknowledges the time-based notification within a prescribed duration.

To support a push service, a push application that provides an interface to the push service at the RMS 101 may be installed on the separate device. Based on installing the push application, a user may verify its identify in the push application and a private/public key pair may be generated and stored at the second device. In some examples, based on verifying the user, the private/public key pair may be generated at a hardware-based, non-portable cryptographic chip that is permanently affixed (e.g., soldered to, adhered to, or any combination thereof) the separate device—e.g., such that the cryptographic chip is unable to be removed with damaging the cryptographic chip. The separate device may also generate an identifier of the private/public key pair (which may be referred to as a “key identifier”) and may store the private/public key pair and key identifier in the cryptographic chip. Based on generating the public/private key pair, the separate device may share the public key and the key identifier with the push service at the RMS 101 to register the public key and the key identifier with the user. The RMS 101 may associate the public key and the key identifier with the user and may store the public key, the key identifier, and the association at the RMS 101.

Subsequently, the user may seek access to a device that requires multiple factors of authentication and is registered with the push service provided by the RMS 101. In some examples, the user may enter login credentials (e.g., a username and password) into the device. Based on verifying the login credentials (e.g., by the device or the RMS 101), the push service may be triggered to send a notification to the push application installed on the separate device for acknowledgment by the user. In some examples, the push service may sign the notification with the public key (and, in some examples, the key identifier) registered for the user at the RMS 101. Based on receiving the notification, the push application may first confirm that the received notification has not been altered (e.g., using the public or private key) and then display the notification to the user. Based on receiving an acknowledgment of the notification, the push application may send a confirmation message to the push service, where the push application may sign the confirmation message with the private key. The push service may verify the authenticity of the confirmation message and may send a message to the device indicating that the user has completed the second factor of authentication. Accordingly, the device may grant the user access to the device.

In some examples, the device (e.g., the first device 113-1) may be unable to connect to the RMS 101 (e.g., the device may be offline, the RMS 101 may be offline, etc.), the separate device (e.g., the second device 113-2) may be unable to connect to the RMS 101 (e.g., the separate device may be offline, the RMS 101 may be offline, etc.), or both. In such cases, the push service at the RMS 101 may be unable to provide the device with a second authentication factor for a user. Accordingly, as a backup option for providing a second authentication factor, the device and the push application installed at the separate device may use a TOTP code as the second authentication factor. That is, the device may calculate a TOTP code based on a TOTP seed that is provided to the device when the device is registered with the push service, where the push application may have the same TOTP seed. Both the device and the push application may use the TOTP seed to concurrently calculate the same set of TOTP codes. Accordingly, when a connection to the push service is unavailable, the user may request a TOTP code from the push application an input the TOTP code into the device to provide a second factor of authentication and gain access to the device.

But TOTP codes, among other issues, may have security vulnerabilities (e.g., if a bad actor obtains the TOTP seed, if the bad actor can generate the same TOTP codes as the push application) and reliability issues (e.g., time drift between devices may cause the TOTP codes generated at corresponding devices to diverge). Thus, mechanisms (e.g., methods, systems, apparatuses, techniques, configurations, components) for generating offline secondary factors of authentication with improved security (e.g., that do not expose/share a secret) and reliability may be desired.

To generate offline secondary factors of authentication with improved security and reliability, a public key generated at a secondary device and an ephemeral key generated at an endpoint device may be used to obtain an encrypted string of randomized characters that is provided to the secondary device, which may decrypt and display the string of randomized characters to the user for entry into the endpoint device.

In some examples, a secondary device (e.g., the second device 113-2) may generate a public/private key pair for a push application that is associated with a user of the secondary device and used to grant the user access to a primary device (e.g., the first device 113-1), where the push application may be associated with a push service at the RMS 101. The secondary device may store the public/private key pair in a cryptographic chip installed at the secondary device along with an identifier of the public/private key pair (which may be referred to as a key identifier) and may provide the public key and key identifier to the push service, where the public key and key identifier may be registered to the user. The primary device may receive the public key and the key identifier from the push service (e.g., based on a user of the primary device completing an authentication procedure with the push service) and may store the public key and key identifier for a multi-factor authentication procedure that can be performed while the primary device, the secondary device, or both, lacks a connection to the push service (e.g., while the primary device, the secondary device, the push service, the RMS 101, or any combination thereof, are offline). In some examples, the multi-factor authentication procedure may also be performed if selected by the user.

Based on the multi-factor authentication procedure being triggered, the primary device may generate a single-use key that is stored in volatile memory of the primary device (and may be referred to as an “ephemeral key”). The primary device may also generate a string of randomized characters (e.g., a random number, a random alphanumeric, etc.) The primary device may use the ephemeral key and the public key to generate a secret that is used to encrypt the string of randomized characters. Based on encrypting the string of randomized characters, the primary device may generate a packet that includes the ephemeral key, the key identifier for the public key, and the encrypted string of randomized characters) and may provide the packet to the secondary device. To provide the packet to the secondary device, the primary device may encode the packet into a quick-response (QR) code and display the QR code—e.g., on a screen of the primary device.

Accordingly, the secondary device may obtain the information in the packet from the primary device (e.g., using a camera and QR decoder to decode the QR code displayed at the primary device). Based on obtaining the information, the secondary device may use the ephemeral key and the private key at the secondary device to obtain the secret for decoding the encrypted string of randomized characters and may obtain the string of randomized characters. The secondary device may display the string of randomized characters (e.g., at a screen of the secondary device) to the user, and the primary device may receive the string of randomized characters in an input provided by the user. Based on determining that the string of randomized character input by the user matches the string of randomized characters generated at the primary device, the primary device may grant the user access to the primary device.

By using a public key of a public/private key pair stored at a secondary device to support an offline multi-factor authentication procedure, the underlying secret supporting the offline multi-factor authentication procedure need not be shared and, thus, is not potentially exposed. Thus, using the public key may increase a security of the multi-factor authentication procedure. Additionally, by using a public key of a public/private key pair stored at a secondary device to support an offline multi-factor authentication procedure, synchronization between the clocks of the corresponding devices may be unnecessary. Thus, using the public key increases a reliability of, and improve a user-experience with, the multi-factor authentication procedure.

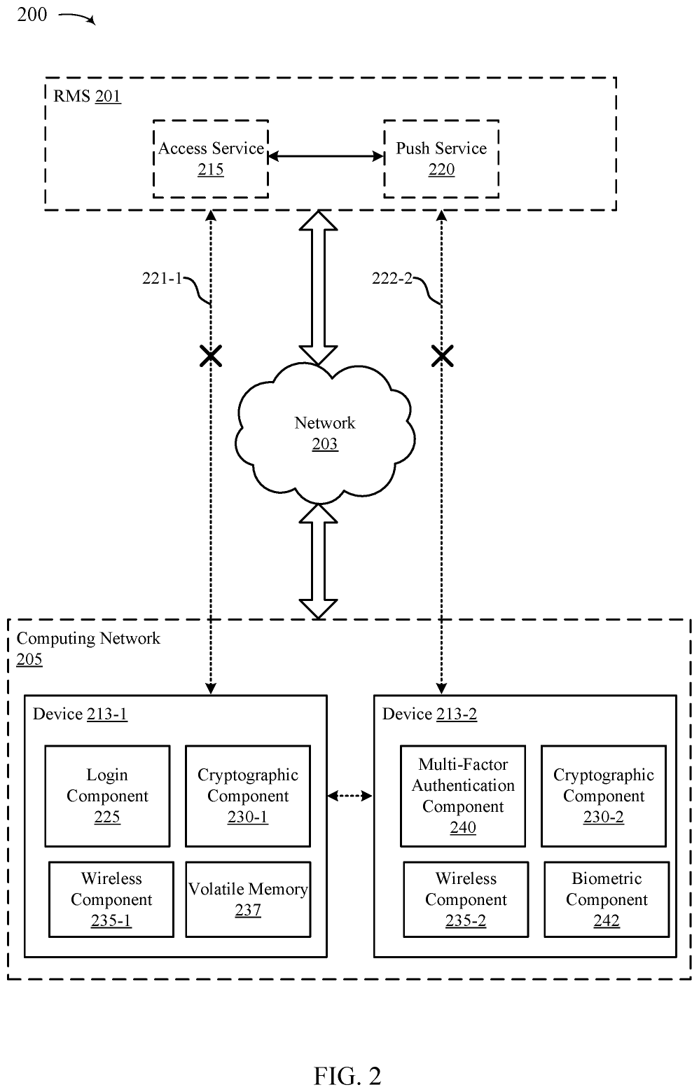

FIG. 2 shows an example of a subsystem that supports offline multi-factor authentication in accordance with examples disclosed herein.

The subsystem 200 may include the RMS 201, the network 203, and the computing network 205, which may be respective examples of an RMS (e.g., the RMS 101 of FIG. 1) a network (e.g., the network 103 of FIG. 1), an external resource (e.g., the first external resource 104-1 of FIG. 1), and a computing network (e.g., the computing network 105 of FIG. 1) described herein.

The RMS 201 may include the access service 215 and the push service 220. The access service 215 may be configured to provide a user access to a device, such as the first device 213-1—e.g., in coordination with an access service at the first device 213-1. The first device 213-1 may be an example of a device (e.g., the first device 213-1 of FIG. 1) described herein. The access service 215 may be configured to detect that a user is attempting to gain access to the first device 213-1—e.g., based on an indication from the login component 225. Based on detecting that a user is attempting to gain access to the first device 213-1, the access service 215 may be configured to determine whether a second factor of authentication is needed for the user to gain access to the first device 213-1. Based on determining that a second factor of authentication is needed, the access service 215 may further determine a process for providing the second factor of authentication—e.g., a push notification via the push service 220. In some examples, the access service 215 is configured to register a user to the first device 213-1 at the RMS 201.

The push service 220 may be configured to obtain a second factor of authentication from a user—e.g., in coordination with the second device 213-2, which may be an example of a device (e.g., the second device 113-2 of FIG. 1) described herein. Prior to using the second device 213-2 to obtain the second factor of authentication, a user of the second device 213-2 may be registered to the second device 213-2 at the push service 220. In some examples, the push service 220 may be configured to send a “push” notification to the second device 213-2 when the user attempts to login to the first device 213-1. Based on receiving a confirmation from the user that the push notification was received, the push service 220 may be configured to provide an indication to the access service 215 (or directly to the login component 225) of the user has been authenticated.

In some examples, the access service 215 and the push service 220 may communicate with the first device 213-1 and the second device 213-2 over the network 203. In some examples, the push service 220 is configured to obtain the second factor of authentication while the first connection 221-1 between the first device 213-1 and the RMS 201 and the second connection 221-2 between the second device 213-2 and the RMS 201 are available. In other examples, a connection between the RMS, the first device 213-1, the second device 213-2, or any combination may be lost (as represented by the X's in FIG. 2). The push service 220 may be unable to operate when the connection is lost—e.g., as the push service 220 may be unable to receive an indication from the first device 213-1 to trigger a push notification, may be unable to send the push notification to the second device 213-2, or any combination thereof.

The first device 213-1 may include the login component 225, the first cryptographic component 230-1, the first wireless component 235-1, and volatile memory 237. The login component 225 may be configured to grant a user access to the first device 213-1—e.g., based on receiving valid credentials from a user of the first device 213-1. In some examples, the login component 225 may require a user to provide multiple factors of authentication provide to granting the user access to the first device 213-1. In such cases, the login component 225 may coordinate with the access service 215, the push service 220, or both, to obtain a second factor of authentication (in addition to a first factor of authentication received from the user at the login component 225). In some examples, a first set of credentials (e.g., a username and password) for accessing the first device 213-1 may be stored within the first device 213-1. In other examples, the first set of credentials may be stored at the access service 215.

The first cryptographic component 230-1 may be configured to store secrets at the first device 213-1 (e.g., certificates, key pairs, etc.). In some examples, the first cryptographic component 230-1 is implemented within a dedicated cryptographic integrated circuit that is located on the first device 213-1 and that can only be accessed by the first device 213-1. That is, the cryptographic integrated circuit may not be moved from the first device 213-1 to another device and, even if the cryptographic integrated circuit is moved to another device, it may be inaccessible. In some examples, the first cryptographic component 230-1 is a dedicated hardware integrated circuit that is permanently (e.g., extremely difficult or impossible to be removed from the first device 213-1 without damage) or semi-permanently (e.g., soldered) fixed to the first device 213-1. Accordingly, private keys stored in the first cryptographic component 230-1 may be known only to the first device 213-1 and may be accessible to the first device 213-1 to the exclusion of all others, including the computing network 205 and the RMS 201. In some examples, the first cryptographic component 230-1 is implemented using Apple's Secure Enclave or Microsoft's Trusted Platform Module (TPM).

The first wireless component 235-1 may be configured to support short-range wireless communication with nearby devices, such as the second device 213-2. In some examples, the first wireless component 235-1 may support a Bluetooth communication protocol. In some examples, the first wireless component 235-1 may establish a connection with the second wireless component 235-2 while the user is logged into the first device 213-1 and may register the second wireless component 235-2 as a trusted device.

The volatile memory 237 may be configured to temporarily store data for the first device 213-1.

The second device 213-2 may include the multi-factor authentication component 240, the second cryptographic component 230-2 (which may be configured similar to the first cryptographic component 230-1), the second wireless component 235-2 (which may be configured similar to the first wireless component 235-1), and the biometric component 242. The multi-factor authentication component 240 may support one or more mechanisms (e.g., a push procedure, a TOTP procedure, a QR secret procedure, etc.) for a user to obtain a second factor of authentication for the first device 213-1. In some examples, the multi-factor authentication component 240 may be configured to implement a multi-factor software application that runs at the second device 213-2. In some examples, a user may register with the push service 220 via the multi-factor authentication component 240. Registering with the push service 220 may include providing the multi-factor authentication component 240 with a credential (e.g., username/password, biometric, etc.) of the user that matches a credential stored for the user at the RMS 201. In some examples, based on the identify of the user being validated, the multi-factor authentication component 240 may generate a public/private key pair that corresponds to the user as well as an identifier of the public/private key pair. The public/private key pair and the key identifier may be stored in the second cryptographic component 230-2.

The multi-factor authentication component 240 may further provide the public key of the second device 213-2 and the corresponding key identifier to the push service 220. The push service 220 may be configured to provide (e.g., in coordination with the access service 215, directly to the first device 213-1, etc.) the public key and/or the key identifier to the first device 213-1 based on registering the user with the push service 220.

The biometric component 242 may be configured to receive a biometric credential (e.g., a fingerprint, voice signature, retinal signature, facial signature, etc.) from a user of the second device 213-2.

In some examples, the login component 225 may field a login attempt from a user while the first connection 221-1 between the first device 213-1 and the RMS 101 is unavailable, the second connection 222-2 between the second device 213-2 and the RMS 101 is unavailable, or both. In some examples, based on the connection(s) being unavailable, the login component 225 may be configured to provide (and/or a user may select) an alternative method for obtaining a second factor of authentication—e.g., a TOTP method, a QR secret method. In some examples (e.g., based on the QR secret method being chosen), the login component 225 may be configured to generate a key (which may be referred to as an ephemeral key) that is temporarily stored in volatile memory of the first device 213-1 and a string of randomized characters (e.g., a randomized alphanumeric, a randomized number, etc.). In some examples, the ephemeral key may be a one-time use key. In some examples, the ephemeral key may be a P-256 key. The login component 225 may be further configured to generate a secret from ephemeral key and the public key of the user received from the RMS 201—e.g., using an elliptic-curve Diffie-Hellman (ECDH)/X9.63 key derivation function (KDF) flow with the ephemeral key and the public key as inputs.

Based on generating the secret, the login component 225 may be configured to use the secret to encrypt the string of randomized characters—e.g., using a nonce as an initialization vector via an AES256GCM encryption flow. In some examples, based on generating the secret, the login component 225 may be configured to use the secret to encrypt the string of randomized characters and a hostname of the first device 213-1. Based on encrypting the string of randomized characters, the login component 225 may be configured generate a packet that includes the public key of the second device 213-2, the key identifier, the nonce used as the initialization vector, and an encrypted payload that includes the string of randomized characters and, in some examples, the hostname. An example packet may be constructed in a JSON format as follows:

```
{
  “pubkey” : <X9.63 format of the ephemeral public key>,
  “nonce” : <nonce used as the IV>,
  “keyid” : <Key ID of the user's public key>,
  “payload” : <cipher text>
}
```

Based on generating the packet, the login component 225 may be configured to encode the content of the packet into a QR image format and may cause the first device 213-1 to display the QR image. In some examples, the QR image is encoded with a prefixed universal resource indicator, such as “offline-push://”. The multi-factor authentication component 240 (e.g., in coordination with a camera at the second device 213-2) may be configured to scan the QR code to extract the content encoded into the QR code. Based on extracting the content, the multi-factor authentication component 240 may be configured to identify the corresponding public/private key pair stored in the second cryptographic component 230-2 based on the extracted key identifier. The multi-factor authentication component 240 (e.g., in coordination with the second cryptographic component 230-2) may use the extracted ephemeral public key and the private key stored at the second device 213-2 to generate a secret that matches the secret previously generated at the first device 213-1 and used to encrypt the payload. In some examples, a biometric credential may be requested from the user before access is provided to the private key.

The multi-factor authentication component 240 may be configured to decrypt the payload using the generated secret and may, thus, obtain the string of randomized characters and, in some examples, the hostname of the first device 213-1. The multi-factor authentication component 240 may be cause the second device 213-2 to display the string of randomized characters and, in some examples, the hostname of the first device 213-1.

A user of the second device 213-2 may input the displayed string of randomized characters into the first device 213-1. The login component 225 may be further configured to compare the inputted string of randomized characters to the previously generated string of randomized characters. Based on the inputted string of randomized characters matching the previously generated string of randomized characters, the login component 225 may be configured to grant the user access to the first device 213-1—e.g., to the operating system and one or more applications installed on the operating system of the first device 213-1.

In some examples, prior to granting the user access to the first device 213-1, the login component 225 (e.g., in coordination with the first wireless component 235-1 and the second wireless component 235-2) may confirm a proximity of the second device 213-2 to the first device 213-1. In such cases, the login component 225 may grant the user access to the first device 213-1 if the second device 213-2 is able to establish a wireless connection (e.g., via Bluetooth) to the first device 213-1. In some examples, the login component 225 may initialize the wireless component when an authentication procedure is triggered.

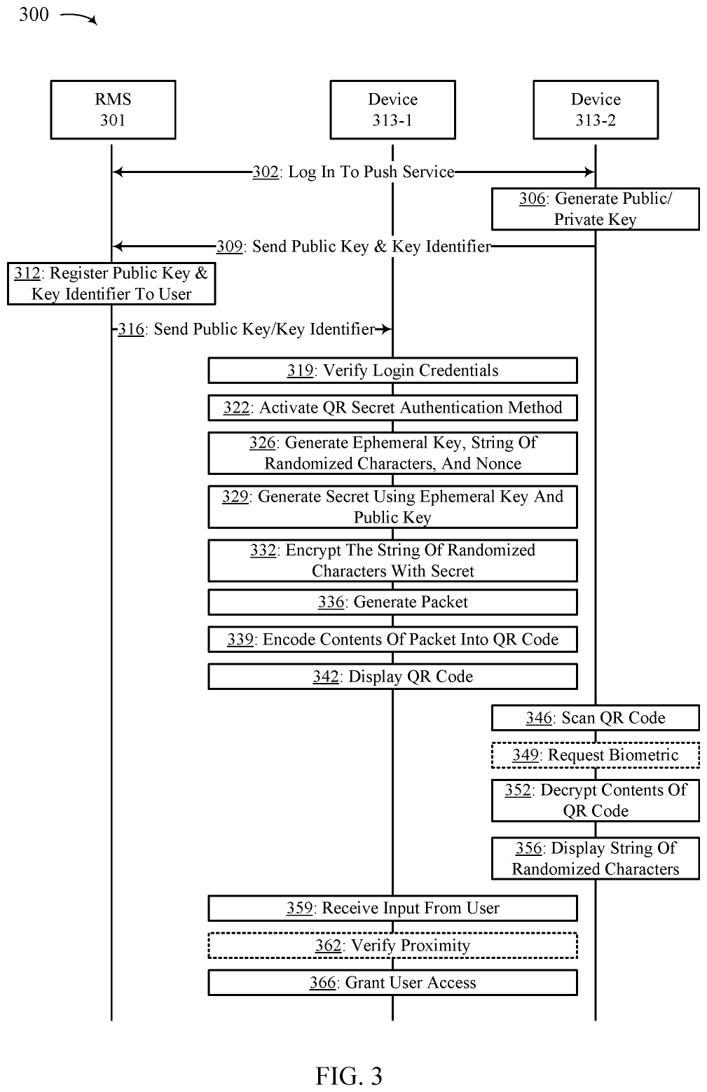

FIG. 3 shows an example of a set of operations for offline multi-factor authentication in accordance with examples disclosed herein.

The process flow 300 may be performed by the RMS 301, which may be an example of an RMS (e.g., the RMS 101 of FIG. 1, the RMS 201 of FIG. 2) described herein. The process flow may also be performed by the first device 313-1 and the second device 313-2, which may be respective examples of a device described herein—e.g., the first device 313-1 may be an example of the first device 113-1 of FIG. 1 or the first device 213-1 of FIG. 2. And the second device 313-2 may be an example of the second device 113-2 of FIG. 1 or the second device 213-2 of FIG. 2. In some examples, the process flow 300 shows an example set of operations performed to support offline multi-factor authentication. For example, the process flow 300 may include operations for using a public key of a second device and an ephemeral key of a first device to encrypt a string of randomized characters that can be encrypted by the second device and displayed to a user of the second device for subsequent entry into the first device.

At 302, a user of the second device 313-2 may be login to a push service (e.g., such as the push service 220 of FIG. 2) hosted by the RMS 301. To log in to the push service, a multi-factor authentication application that has access to the push service may be installed at the second device 313-2. In such cases, a user may enter credentials into the multi-factor authentication application, and after verifying the credentials of the user, the push service may confirm that that the user is in possession of the second device 313-2.

At 306, based on the identity of the user being confirmed, a public/private key pair may be generated (e.g., by a cryptographic component, such as the second cryptographic component 230-2 of FIG. 2) at the second device 313-2 for the user. Based on generating the public/private key pair, the cryptographic component may further generate an identifier of the public/private key par. The public/private key pair and the key identifier may be stored in the cryptographic component.

At 309, the public key and the key identifier may be sent to the push service (e.g., by the multi-factor authentication application). In some examples, the message including the public key and the key identifier may be signed by the public key or the private key of the public/private key pair.

At 312, the public key and the key identifier may be registered to the user at the push service. In some examples, the public key and the key identifier may be linked to resources that are associated with the user (e.g., the first device 313-1) by the RMS 301. Resources that are allocated to the user by the RMS 101, resources registered by a user with the RMS 101, resources at which a user has logged in, and the like, may be associated with the user.

At 316, the public key and the key identifier may be sent to the first device 313-1—e.g., based on the first device 313-1 being associated with the user. In some examples, the public key and the key identifier may be sent to additional devices associated with the user. In some examples, the RMS 301 sends the public key and key identifier to the devices associated with the user if the user has activated multi-factor authentication protection. In some examples, the RMS 301 sends the public key and key identifier to a subset of the devices associated with the user for which multi-factor authentication protection is activated (e.g., by the user, by a security policy managed by the RMS 301, etc.). The first device 313-1 may store the public key and the key identifier—e.g., in non-volatile memory.

At 319, login credentials (e.g., a username and password, a biometric, etc.) for a user may be inputted into the first device 313-1 and verified. Based on verifying the login credentials, the first device 313-1 may initiate a procedure for obtaining a second factor of authentication. In some examples, prior to initiating the procedure, the first device 313-1 may determine whether a connection is available between the first device 313-1 and the RMS 301.

At 322, a procedure for obtaining a second factor of authentication may be activated at the first device 313-1. In some examples, the procedure (which may be referred to as a QR secret procedure) involves using the public key received from the RMS 301 to encrypt a string of randomized characters to include in a QR code for decryption by a separate authenticating device. In some examples, the QR secret procedure is activated based on the first device 313-1 identifying that a connection with the RMS 301 is unavailable—e.g., if the first device 313-1 is offline, the RMS 301 is offline, etc. In some examples, the QR secret procedure is activated based on the first device 313-1 identifying that a connection between the RMS 301 and the second device 313-2 is unavailable—e.g., if the push service indicates to the first device 313-1 that the RMS 301 was unable to reach the second device 313-2. In some examples, the QR secret procedure is activated based on a suer of the first device 313-1 selecting this option for obtaining the second factor of authentication (e.g., based on knowledge that the first device 313-1, the second device 313-2, or both do not have a connection to the RMS 301).

At 326, based on the QR secret procedure being activated, an ephemeral key may be generated (e.g., by a cryptographic component at the first device 313-1) and stored in a volatile memory location at the first device 313-1 Also, a string of randomized characters (e.g., an randomized alphanumeric, a randomized number, etc.) may be generated (e.g., using a random character generator at the first device 313-1). Additionally, a nonce (which may be 12 bytes of randomness) may be generated (e.g., using the random character generator).

At 329, a secret may be generated using the ephemeral key and the public key. In some examples, an ECDH/X9.63 KDF flow is used to generate the shared secret, where the ephemeral key and the public key may be used as inputs to the flow.

At 332, the string of randomized characters may be encrypted with the generated secret. Encrypting the string of randomized characters may include using the generated nonce as an initialization vector for an AES256GMC encryption flow. In some examples, a hostname of the first device 313-1 may also be encrypted with the string of randomized characters. The encryption may result in encrypted data.

At 336, a packet may be generated. The packet may include the generated ephemeral key, the generated nonce, the key identifier received from the RMS 301, and the encrypted data (which may be referred to as the payload of the packet). In some examples, the packet is generated in accordance with a JSON format as described herein.

At 339, the contents of the packet may be encoded into a QR code format. In some examples, the contents are base64 encoded with a prefixed universal resource identifier of “offline-push://”.

At 342, the QR code may be displayed at the first device 313-1—e.g., at a location of a screen of the first device 313-1. In some examples, based on generating the ephemeral key, generating the string of randomized characters, generating the QR code, displaying the QR code, or some combination thereof, the first device 313-1 may initiate a timer during which time the string of randomized characters is a valid factor of authentication for a user. In such cases, if a user fails to input the string of randomized characters into the first device 313-1 prior to an expiration of the timer, the string of randomized characters may expire as a second factor of authentication.

In some examples, based on displaying the QR code, a field for a user to input the string of randomized characters embedded within the QR code may be displayed (e.g., beneath the QR code). In other examples, a button may be displayed (e.g., beneath the QR code) that navigates a user to a field for the user to input the string of randomized characters—e.g., where the user may wait to select the button until the string of randomized characters is obtained from the second device 313-2. Alternatively, a window including the field for the user to input the string of randomized characters may be automatically displayed to the user after the QR code has been displayed for an amount of time.

At 346, the QR code displayed at the first device 313-1 may be scanned by the second device 313-2. In some examples, the QR code is scanned by the second device 313-2 using a camera of the second device 313-2. Based on scanning the QR code, the multi-factor authentication application may extract the contents of the QR code, including the ephemeral key, the nonce, the key identifier, and the encrypted data.

At 349, prior to decrypting the contents of the encrypted data, a request for a biometric authentication may be provided to a user. In such cases, the user may provide a biometric to a biometric component at the second device 313-2. In such cases, if the biometric being validated by the biometric component, the multi-factor authentication application may proceed with the process for decrypting the encrypted data.

At 352, the encrypted data received from the QR code may be decrypted. In some examples, to decrypt the encrypted data, the multi-factor authentication application may send the ephemeral key and the key identifier to the cryptographic component at the second device 313-2. The cryptographic component at the second device 313-2 may identify the public/private key pair using the key identifier and may generate a secret from the ephemeral key and the private key, where the secret may match (or be symmetric to) the secret previously generated at the first device 313-1. The multi-factor authentication application may then receive the secret from the cryptographic component and may decrypt the encrypted data with the secret. Based on decrypting the encrypted data, the multi-factor authentication application may obtain the string of randomized characters and, in some examples, a hostname of the first device 313-1.

At 356, the string of randomized characters may be displayed at the second device 313-2—e.g., at a location on the screen of the second device 313-2. The hostname of the first device 313-1 may also be displayed to enable a user to verify the device that generated the string of randomized characters.

At 359, based on the string of randomized characters being displayed at the second device 313-2, an input from the user may be received at the first device 313-1. The input may be the string of randomized characters displayed at the second device 313-2.

At 362, after receiving the valid string of randomized characters and prior to granting the user access to the first device 313-1, a proximity of the second device 313-2 (and thereby the user) to the first device 313-1 may be verified. In some examples, to verify the proximity of the second device 313-2 to the first device 313-1, a short-range wireless connection between the first device 313-1 and the second device 313-2 may be confirmed. For example, a set of messages may be exchanged between the first device 313-1 and the second device 313-2 that confirms that the second device 313-2 (which may have been previously registered at the first device 313-1 using the wireless communication technology) is within a transmission/reception range of the first device 313-1 using the wireless communication technology. The wireless communication technology may be Bluetooth, Wi-Fi, near-field communication, and the like.

At 366, a user may be granted access to the first device 313-1—e.g., if the string of randomized characters inputted into the first device 313-1 matches the string of randomized characters previously generated by the first device 313-1. In some examples, despite a match, access may only be granted to the first device if the string of randomized characters previously generated by the first device 313-1 has not yet expired, if the second device 313-2 is verified to be within a proximity of the first device 313-1, or both.

Aspects of the process flow 300 may be implemented by a controller, among other components. Additionally, or alternatively, aspects of the process flow 300 may be implemented as instructions stored in memory (e.g., firmware stored in a memory coupled with a controller). For example, the instructions, when executed by a controller, may cause the controller to perform the operations of the process flow 300.

One or more of the operations described in the process flow 300 may be performed earlier or later, omitted, replaced, supplemented, or combined with another operation. Also, additional operations described herein may replace, supplement or be combined with one or more of the operations described in the process flow 300.

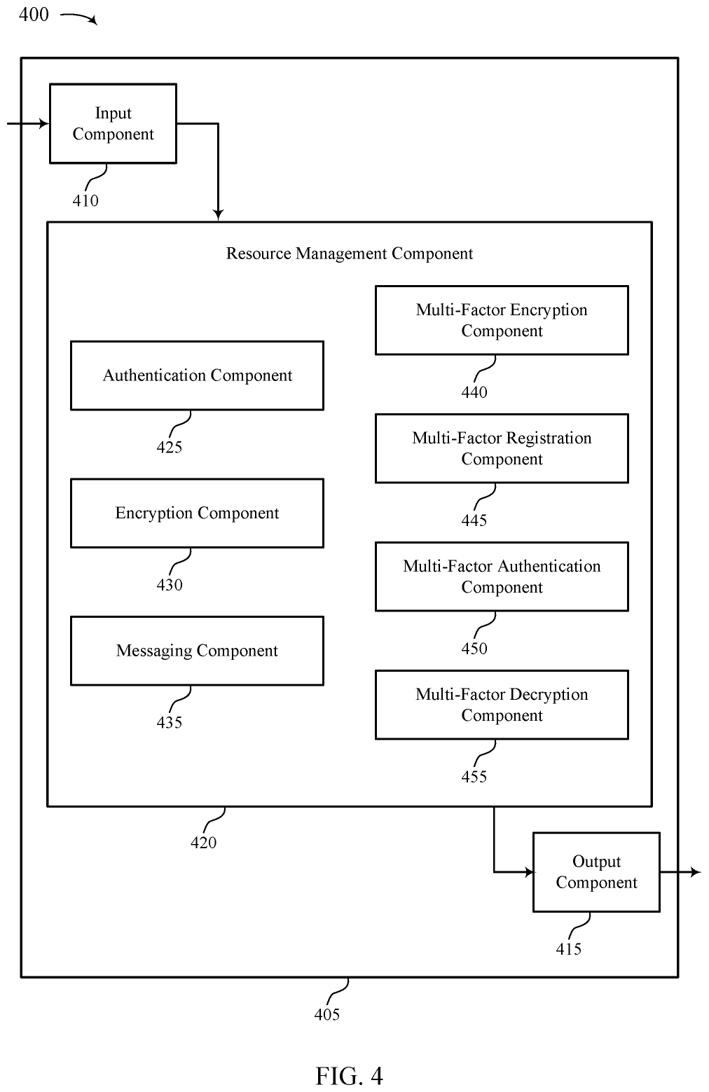

FIG. 4 shows an example of a device that supports offline multi-factor authentication in accordance with aspects of the present disclosure.

The device 405 may be an example of aspects of one or more components described with reference to FIG. 1, such as one or more of the devices 113. The device 405 may include an input component 410, an output component 415, and a resource management component 420. The device 405 may also include one or more processors. Each of these components may be in communication with one another (e.g., via one or more buses, communications links, communications interfaces, or any combination thereof).

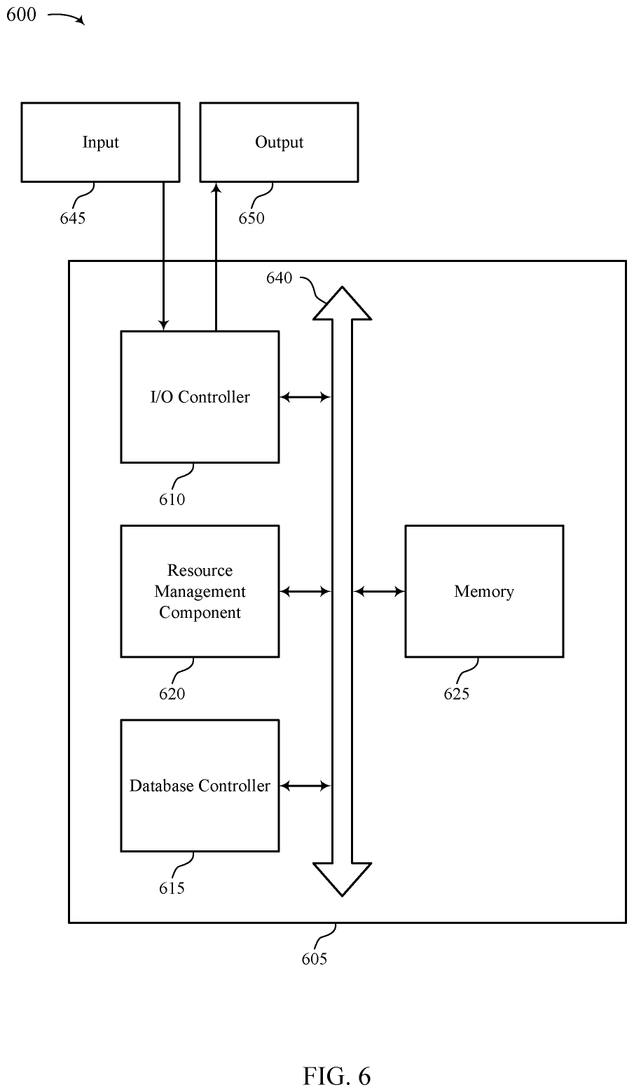

The input component 410 may manage input signals for the device 405. For example, the input component 410 may identify input signals based on an interaction with a modem, a keyboard, a mouse, a touchscreen, or a similar device. These input signals may be associated with user input or processing at other components or devices. In some cases, the input component 410 may utilize an operating system such as iOS®, ANDROID®, MS-DOS®, MS-WINDOWS®, OS/2®, UNIX®, LINUX®, or another known operating system to handle input signals. The input component 410 may send aspects of these input signals to other components of the device 405 for processing. For example, the input component 410 may transmit input signals to the resource management component 420 to support offline multi-factor authentication. In some cases, the input component 410 may be a component of an I/O controller 610 as described with reference to FIG. 6.

The output component 415 may manage output signals for the device 405. For example, the output component 415 may receive signals from other components of the device 405, such as the resource management component 420, and may transmit these signals to other components or devices. In some specific examples, the output component 415 may transmit output signals for display in a user interface, for storage in a database or data store, for further processing at a server or server cluster, or for any other processes at any number of devices or systems. In some cases, the output component 415 may be a component of an I/O controller 610 as described with reference to FIG. 6.

For example, the resource management component 420 may include an authentication component 425, an encryption component 430, a messaging component 435, a multi-factor encryption component 440, a multi-factor registration component 445, a multi-factor authentication component 450, a multi-factor decryption component 455, or any combination thereof. In some examples, the resource management component 420, or various components thereof, may be configured to perform various operations (e.g., receiving, monitoring, transmitting) using or otherwise in cooperation with the input component 410, the output component 415, or both. For example, the resource management component 420 may receive information from the input component 410, send information to the output component 415, or be integrated in combination with the input component 410, the output component 415, or both to receive information, transmit information, or perform various other operations as described herein.

The authentication component 425 may be configured as or otherwise support a means for receiving, from a resource management system, a public key of a second device and an identifier of the public key, where the public key corresponds to a private key of the second device stored at the second device, is referenceable at the resource management system and the second device using the identifier of the public key, and is associated with a user at the second device and the resource management system. The encryption component 430 may be configured as or otherwise support a means for encrypting, in response to a request to access the first device, a string of randomized characters using a secret generated from an ephemeral key generated at the first device and stored in volatile memory of the first device and the public key, where encrypted data is obtained based on encrypting the string of randomized characters. The messaging component 435 may be configured as or otherwise support a means for generating, based on encrypting the string of randomized characters, a packet including the ephemeral key, the identifier of the public key, and the encrypted data. The messaging component 435 may be configured as or otherwise support a means for providing, based on generating the packet and in response to the request to access the first device, the packet to the second device for decryption. The authentication component 425 may be configured as or otherwise support a means for receiving, based on sending the packet to the second device for decryption, from the user, an input including the string of randomized characters. The authentication component 425 may be configured as or otherwise support a means for authenticating, based on receiving the input, the user for access to the first device.

The multi-factor encryption component 440 may be configured as or otherwise support a means for generating, for a user of the second device, a public key of the second device and an identifier of the public key, where the public key corresponds to a private key of the second device. The multi-factor registration component 445 may be configured as or otherwise support a means for registering, by the second device at a resource management system, the public key and the identifier of the public key to the user generated by the second device. The multi-factor authentication component 450 may be configured as or otherwise support a means for receiving, from a first device, based on the user requesting access to the first device, a packet including an ephemeral key generated at the first device, the identifier of the public key, and encrypted data that was encrypted using a secret generated from the public key and the ephemeral key. The multi-factor decryption component 455 may be configured as or otherwise support a means for decrypting the encrypted data using the private key, where a string of randomized characters that provides the user access to the first device is obtained based on decrypting the encrypted data. The multi-factor authentication component 450 may be configured as or otherwise support a means for displaying the string of randomized characters for the user to input into the first device.

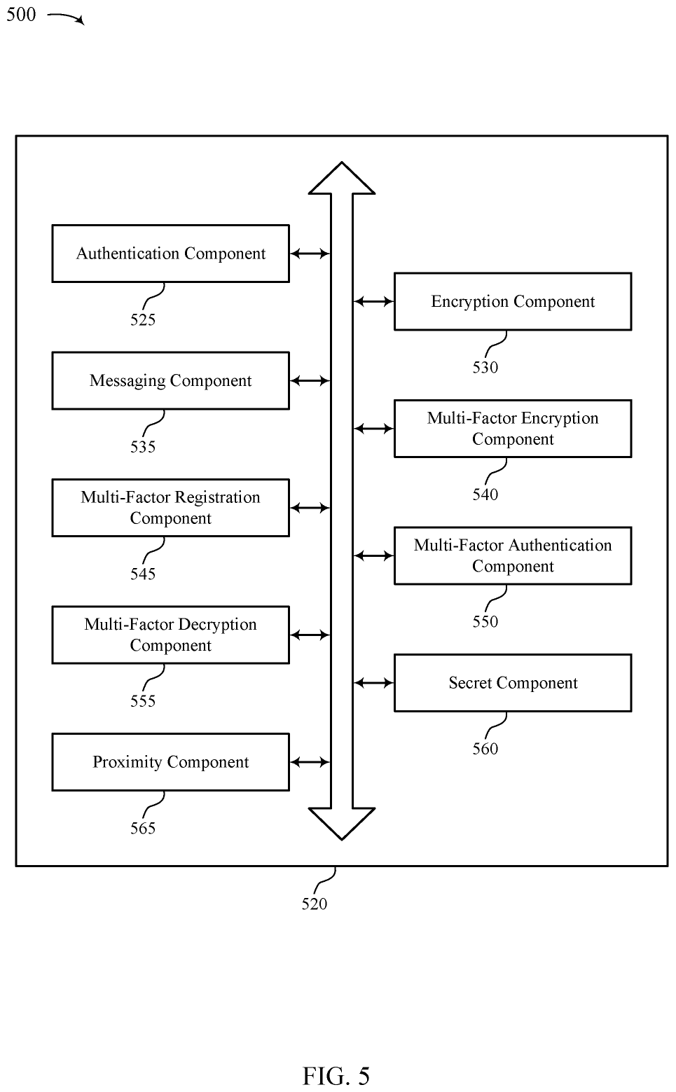

FIG. 5 shows an example of a resource management component 520 that supports offline multi-factor authentication in accordance with aspects of the present disclosure.

The resource management component 520 may be an example of aspects of a resource management component or a resource management component 420, or both, as described herein. The resource management component 520, or various components thereof, may be an example of means for performing various aspects of offline multi-factor authentication as described herein. For example, the resource management component 520 may include an authentication component 525, an encryption component 530, a messaging component 535, a multi-factor encryption component 540, a multi-factor registration component 545, a multi-factor authentication component 550, a multi-factor decryption component 555, a secret component 560, a proximity component 565, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The authentication component 525 may be configured as or otherwise support a means for receiving, from a resource management system, a public key of a second device and an identifier of the public key, where the public key corresponds to a private key of the second device stored at the second device, is referenceable at the resource management system and the second device using the identifier of the public key, and is associated with a user at the second device and the resource management system. The encryption component 530 may be configured as or otherwise support a means for encrypting, in response to a request to access the first device, a string of randomized characters using a secret generated from an ephemeral key generated at the first device and stored in volatile memory of the first device and the public key, where encrypted data is obtained based on encrypting the string of randomized characters. The messaging component 535 may be configured as or otherwise support a means for generating, based on encrypting the string of randomized characters, a packet including the ephemeral key, the identifier of the public key, and the encrypted data. In some examples, the messaging component 535 may be configured as or otherwise support a means for providing, based on generating the packet and in response to the request to access the first device, the packet to the second device for decryption. In some examples, the authentication component 525 may be configured as or otherwise support a means for receiving, based on sending the packet to the second device for decryption, from the user, an input including the string of randomized characters. In some examples, the authentication component 525 may be configured as or otherwise support a means for authenticating, based on receiving the input, the user for access to the first device.

In some examples, the authentication component 525 may be configured as or otherwise support a means for receiving, after receiving the public key from the resource management system and prior to generating the packet, the request to access the first device. In some examples, the authentication component 525 may be configured as or otherwise support a means for determining that a connection between the first device and the resource management system is unavailable, a connection between the second device and the resource management system is unavailable, or both, where the string of randomized characters is encrypted based on the determining.

In some examples, the encryption component 530 may be configured as or otherwise support a means for generating, after receiving the public key and in response to the request to access the first device, the ephemeral key. In some examples, the secret component 560 may be configured as or otherwise support a means for generating, based on generating the ephemeral key, the secret from the public key received from the resource management system and the ephemeral key generated at the first device.

In some examples, the authentication component 525 may be configured as or otherwise support a means for generating, after receiving the public key and in response to the request to access the first device, the string of randomized characters.

In some examples, a hostname of the first device is encrypted with the string of randomized characters. In some examples, the encrypted data is obtained based on encrypting the string of randomized characters and the hostname.

In some examples, providing the packet to the second device includes generating a quick-response code that represents a content of the packet; and displaying, at the first device, the quick-response code.

In some examples, the encrypted data is decryptable using the ephemeral key generated by the first device and the private key stored at the second device.

In some examples, the authentication component 525 may be configured as or otherwise support a means for authenticating, prior to receiving the public key from the resource management system, the user for access to the first device, where the public key and the identifier of the public key is received at the first device in response to the user being authenticated for access to the first device via the resource management system.

In some examples, the proximity component 565 may be configured as or otherwise support a means for communicating wireless signaling with the second device. In some examples, the proximity component 565 may be configured as or otherwise support a means for confirming, based on the wireless signaling, that a proximity between the first device and the second device is less than a threshold, where the user is authenticated for access to the first device based on the proximity being less than the threshold.

The multi-factor encryption component 540 may be configured as or otherwise support a means for generating, for a user of the second device, a public key of the second device and an identifier of the public key, where the public key corresponds to a private key of the second device. The multi-factor registration component 545 may be configured as or otherwise support a means for registering, by the second device at a resource management system, the public key and the identifier of the public key to the user generated by the second device. The multi-factor authentication component 550 may be configured as or otherwise support a means for receiving, from a first device, based on the user requesting access to the first device, a packet including an ephemeral key generated at the first device, the identifier of the public key, and encrypted data that was encrypted using a secret generated from the public key and the ephemeral key. The multi-factor decryption component 555 may be configured as or otherwise support a means for decrypting the encrypted data using the private key, where a string of randomized characters that provides the user access to the first device is obtained based on decrypting the encrypted data. In some examples, the multi-factor authentication component 550 may be configured as or otherwise support a means for displaying the string of randomized characters for the user to input into the first device.

In some examples, the packet is received based on a connection between the second device and the resource management system being unavailable, a connection between the first device and the resource management system being unavailable, or both.

In some examples, the multi-factor registration component 545 may be configured as or otherwise support a means for verifying, prior to generating the public key, an identity of the user with the resource management system, where the public key is generated based on the identity of the user being verified by the resource management system.

In some examples, the multi-factor encryption component 540 may be configured as or otherwise support a means for storing, prior to receiving the packet, the public key, the private key, and the identifier of the public key in a cryptographic component of the second device.

In some examples, the multi-factor decryption component 555 may be configured as or otherwise support a means for generating, based on receiving the packet, the secret using the ephemeral key received in the packet and the private key stored at the second device.

In some examples, receiving the packet includes decoding a quick-response code being displayed at the first device.

In some examples, a hostname of the first device is obtained based on decrypting the encrypted data, and where the hostname is displayed to the user with the string of randomized characters.

In some examples, the multi-factor decryption component 555 may be configured as or otherwise support a means for requesting, based on receiving the packet, the user to authenticate an identity of the user using a biometric component of the second device, where the string of randomized characters is displayed to the user based on the biometric component authenticating the identity of the user.

In some examples, the multi-factor authentication component 550 may be configured as or otherwise support a means for receiving, from the resource management system, based on the user requesting access to the first device, a request for the user to verify that the user is requesting access to the first device based on a connection between the second device and the resource management system being available and a connection between the first device and the resource management system being available. In some examples, the multi-factor authentication component 550 may be configured as or otherwise support a means for sending, to the resource management system, a response configured to verify that the user is requesting access to the first device and to trigger the resource management system to send a message to the first device authenticating the user for access to the first device.

FIG. 6 shows an example of a device that supports offline multi-factor authentication in accordance with aspects of the present disclosure.

The device 605 may be an example of or include the components of a device 405 as described herein. The device 605 may include components for resource management, including components such as the resource management component 620, the I/O controller 610, the database controller 615, at least one memory (such as the memory 625), at least one processor (such as the processor 630), and the database 635. These components may be in electronic communication or otherwise coupled with each other (e.g., operatively, communicatively, functionally, electronically, electrically; via one or more buses, communications links, communications interfaces, or any combination thereof). Additionally, the components of the device 605 may include corresponding physical components or may be implemented as corresponding virtual components (e.g., components of one or more virtual machines).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. Additionally, or alternatively, the I/O controller 610 may represent or interact with a modem, a keyboard, a mouse, a touchscreen, or a similar device. In some cases, the I/O controller 610 may be implemented as part of a processor. In some examples, a user may interact with the device 605 via the I/O controller 610 or via hardware components controlled by the I/O controller 610.

The database controller 615 may manage data storage and processing in a database 635. The database 635 may be external to the device 605, temporarily or permanently connected to the device 605, or a data storage component of the device 605. In some cases, a user may interact with the database controller 615. In some other cases, the database controller 615 may operate automatically without user interaction. The database 635 may be an example of a persistent data store, a single database, a distributed database, multiple distributed databases, a database management system, or an emergency backup database.

Memory 625 may include random-access memory (RAM) and ROM. The memory 625 may store computer-readable, computer-executable software including instructions that, when executed, cause the processor to perform various functions described herein. In some cases, the memory 625 may contain, among other things, a BIOS which may control basic hardware or software operation such as the interaction with peripheral components or devices.

The processor 630 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 630 may be configured to operate a memory array using a memory controller. In some other cases, a memory controller may be integrated into the processor 630. The processor 630 may be configured to execute computer-readable instructions stored in memory 625 to perform various functions (e.g., functions or tasks supporting offline multi-factor authentication).

For example, the resource management component 620 may be configured as or otherwise support a means for receiving, from a resource management system, a public key of a second device and an identifier of the public key, where the public key corresponds to a private key of the second device stored at the second device, is referenceable at the resource management system and the second device using the identifier of the public key, and is associated with a user at the second device and the resource management system. The resource management component 620 may be configured as or otherwise support a means for encrypting, in response to a request to accessing the first device, a string of randomized characters using a secret generated from an ephemeral key generated at the first device and stored in volatile memory of the first device and the public key, where encrypted data is obtained based on encrypting the string of randomized characters. The resource management component 620 may be configured as or otherwise support a means for generating, based on encrypting the string of randomized characters, a packet including the ephemeral key, the identifier of the public key, and the encrypted data. The resource management component 620 may be configured as or otherwise support a means for providing, basing on generating the packet and in response to the request to access the first device, the packet to the second device for decryption. The resource management component 620 may be configured as or otherwise support a means for receiving, based on sending the packet to the second device for decryption, from the user, an input including the string of randomized characters. The resource management component 620 may be configured as or otherwise support a means for authenticating, basing on receiving the input, the user for access to the first device.

For example, the resource management component 620 may be configured as or otherwise support a means for generating, for a user of the second device, a public key of the second device and an identifier of the public key, where the public key corresponds to a private key of the second device. The resource management component 620 may be configured as or otherwise support a means for registering, by the second device at a resource management system, the public key and the identifier of the public key to the user generated by the second device. The resource management component 620 may be configured as or otherwise support a means for receiving, from a first device, based on the user requesting access to the first device, a packet including an ephemeral key generated at the first device, the identifier of the public key, and encrypted data that was encrypted using a secret generated from the public key and the ephemeral key. The resource management component 620 may be configured as or otherwise support a means for decrypting the encrypted data using the private key, where a string of randomized characters that provides the user access to the first device is obtained based on decrypting the encrypted data. The resource management component 620 may be configured as or otherwise support a means for displaying the string of randomized characters for the user to input into the first device.

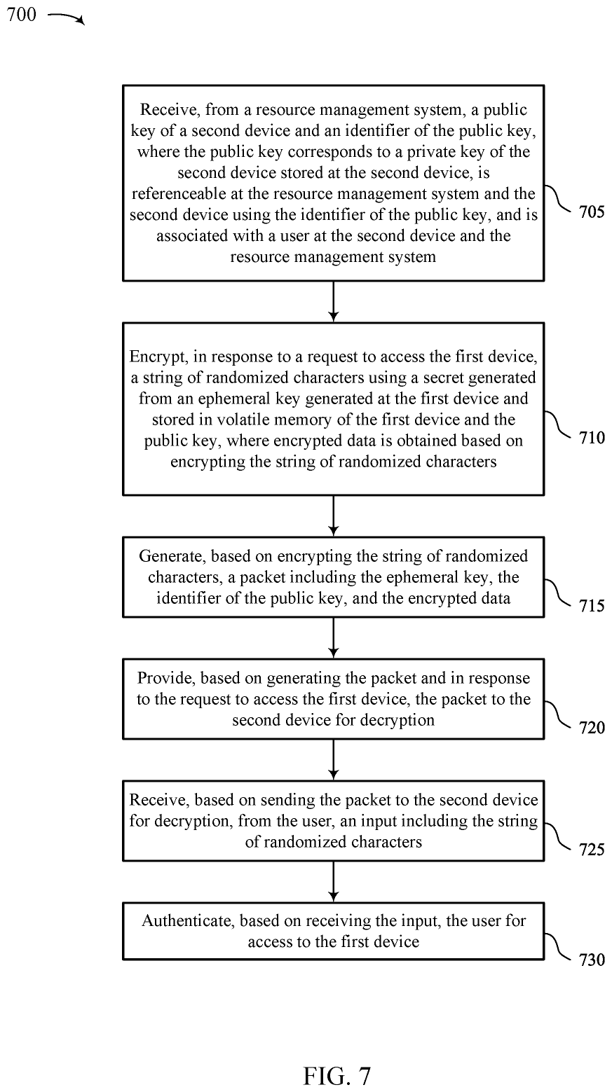

FIG. 7 shows an example of a set of operations for offline multi-factor authentication in accordance with aspects of the present disclosure.

The method 700 (and its operations) may be implemented by a device or its components as described herein. For example, the operations of the method 700 may be performed by a device as described with reference to FIGS. 1 through 6. In some examples, a device may execute a set of instructions to control the functional elements of the device to perform the described functions. Additionally, or alternatively, the device may perform aspects of the described functions using special-purpose hardware.

At 705, the method may include receiving, from a resource management system, a public key of a second device and an identifier of the public key, where the public key corresponds to a private key of the second device stored at the second device, is referenceable at the resource management system and the second device using the identifier of the public key, and is associated with a user at the second device and the resource management system. The operations of 705 may be performed in accordance with examples as disclosed herein. In some examples, aspects of the operations of 705 may be performed by an authentication component 525 as described with reference to FIG. 5.

At 710, the method may include encrypting, in response to a request to access the first device, a string of randomized characters using a secret generated from an ephemeral key generated at the first device and stored in volatile memory of the first device and the public key, where encrypted data is obtained based on encrypting the string of randomized characters. The operations of 710 may be performed in accordance with examples as disclosed herein. In some examples, aspects of the operations of 710 may be performed by an encryption component 530 as described with reference to FIG. 5.

At 715, the method may include generating, based on encrypting the string of randomized characters, a packet including the ephemeral key, the identifier of the public key, and the encrypted data. The operations of 715 may be performed in accordance with examples as disclosed herein. In some examples, aspects of the operations of 715 may be performed by a messaging component 535 as described with reference to FIG. 5.

At 720, the method may include providing, based on generating the packet and in response to the request to access the first device, the packet to the second device for decryption. The operations of 720 may be performed in accordance with examples as disclosed herein. In some examples, aspects of the operations of 720 may be performed by a messaging component 535 as described with reference to FIG. 5.

At 725, the method may include receiving, based on sending the packet to the second device for decryption, from the user, an input including the string of randomized characters. The operations of 725 may be performed in accordance with examples as disclosed herein. In some examples, aspects of the operations of 725 may be performed by an authentication component 525 as described with reference to FIG. 5.

At 730, the method may include authenticating, based on receiving the input, the user for access to the first device. The operations of 730 may be performed in accordance with examples as disclosed herein. In some examples, aspects of the operations of 730 may be performed by an authentication component 525 as described with reference to FIG. 5.

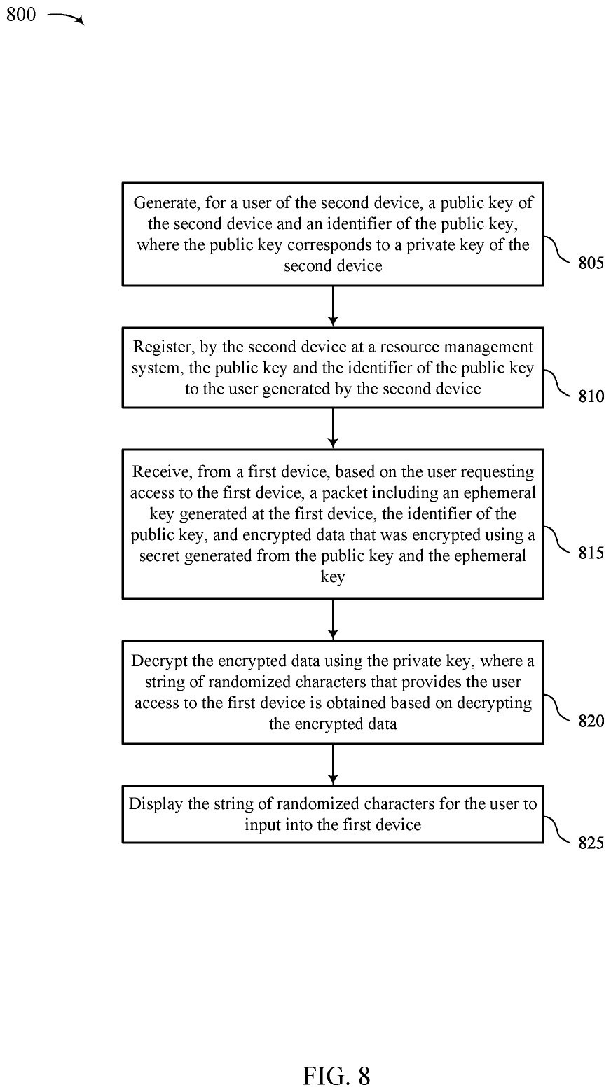

FIG. 8 shows an example of a set of operations for offline multi-factor authentication in accordance with aspects of the present disclosure.

The method 800 (and its operations) may be implemented by a device or its components as described herein. For example, the operations of the method 800 may be performed by a device as described with reference to FIGS. 1 through 6. In some examples, a device may execute a set of instructions to control the functional elements of the device to perform the described functions. Additionally, or alternatively, the device may perform aspects of the described functions using special-purpose hardware.

At 805, the method may include generating, for a user of the second device, a public key of the second device and an identifier of the public key, where the public key corresponds to a private key of the second device. The operations of 805 may be performed in accordance with examples as disclosed herein. In some examples, aspects of the operations of 805 may be performed by a multi-factor encryption component 540 as described with reference to FIG. 5.

At 810, the method may include registering, by the second device at a resource management system, the public key and the identifier of the public key to the user generated by the second device. The operations of 810 may be performed in accordance with examples as disclosed herein. In some examples, aspects of the operations of 810 may be performed by a multi-factor registration component 545 as described with reference to FIG. 5.

At 815, the method may include receiving, from a first device, based on the user requesting access to the first device, a packet including an ephemeral key generated at the first device, the identifier of the public key, and encrypted data that was encrypted using a secret generated from the public key and the ephemeral key. The operations of 815 may be performed in accordance with examples as disclosed herein. In some examples, aspects of the operations of 815 may be performed by a multi-factor authentication component 550 as described with reference to FIG. 5.

At 820, the method may include decrypting the encrypted data using the private key, where a string of randomized characters that provides the user access to the first device is obtained based on decrypting the encrypted data. The operations of 820 may be performed in accordance with examples as disclosed herein. In some examples, aspects of the operations of 820 may be performed by a multi-factor decryption component 555 as described with reference to FIG. 5.

At 825, the method may include displaying the string of randomized characters for the user to input into the first device. The operations of 825 may be performed in accordance with examples as disclosed herein. In some examples, aspects of the operations of 825 may be performed by a multi-factor authentication component 550 as described with reference to FIG. 5.

The following provides an overview of aspects of the present disclosure:

Aspect 1: A method at a first device (113-1), comprising: receiving, from a resource management system (101), a public key of a second device (113-2) and an identifier of the public key, wherein the public key corresponds to a private key of the second device stored at the second device, is referenceable at the resource management system and the second device using the identifier of the public key, and is associated with a user at the second device and the resource management system; encrypting, in response to a request to access the first device, a string of randomized characters using a secret generated from an ephemeral key generated at the first device and stored in volatile memory (237) of the first device and the public key, wherein encrypted data is obtained based on encrypting the string of randomized characters; generating, based on encrypting the string of randomized characters, a packet comprising the ephemeral key, the identifier of the public key, and the encrypted data; providing, based on generating the packet and in response to the request to access the first device, the packet to the second device for decryption; receiving, based on sending the packet to the second device for decryption, from the user, an input comprising the string of randomized characters; and authenticating, based on receiving the input, the user for access to the first device.

Aspect 2: The method of aspect 1, further comprising: receiving, after receiving the public key from the resource management system and prior to generating the packet, the request to access the first device; and determining that a connection (221-1) between the first device and the resource management system is unavailable, a connection (221-2) between the second device and the resource management system is unavailable, or both, wherein the string of randomized characters is encrypted based on the determining.

Aspect 3: The method of any of aspects 1 through 2, further comprising: generating, after receiving the public key and in response to the request to access the first device, the ephemeral key; and generating, based on generating the ephemeral key, the secret from the public key received from the resource management system and the ephemeral key generated at the first device.

Aspect 4: The method of any of aspects 1 through 3, further comprising: generating, after receiving the public key and in response to the request to access the first device, the string of randomized characters.

Aspect 5: The method of any of aspects 1 through 4, wherein a hostname of the first device is encrypted with the string of randomized characters, and the encrypted data is obtained based on encrypting the string of randomized characters and the hostname.

Aspect 6: The method of any of aspects 1 through 5, wherein providing the packet to the second device comprises generating a quick-response code that represents a content of the packet; and displaying, at the first device, the quick-response code.

Aspect 7: The method of any of aspects 1 through 6, wherein the encrypted data is decryptable using the ephemeral key generated by the first device and the private key stored at the second device.

Aspect 8: The method of any of aspects 1 through 7, further comprising: authenticating, prior to receiving the public key from the resource management system, the user for access to the first device, wherein the public key and the identifier of the public key is received at the first device in response to the user being authenticated for access to the first device via the resource management system.

Aspect 9: The method of any of aspects 1 through 8, further comprising: communicating wireless signaling with the second device; and confirming, based on the wireless signaling, that a proximity between the first device and the second device is less than a threshold, wherein the user is authenticated for access to the first device based on the proximity being less than the threshold.

Aspect 10: A method at a second device (113-2), comprising: generating, for a user of the second device, a public key of the second device and an identifier of the public key, wherein the public key corresponds to a private key of the second device; registering, by the second device at a resource management system (101), the public key and the identifier of the public key to the user generated by the second device; receiving, from a first device (113-1), based on the user requesting access to the first device, a packet comprising an ephemeral key generated at the first device, the identifier of the public key, and encrypted data that was encrypted using a secret generated from the public key and the ephemeral key; decrypting the encrypted data using the private key, wherein a string of randomized characters that provides the user access to the first device is obtained based on decrypting the encrypted data; and displaying the string of randomized characters for the user to input into the first device.

Aspect 11: The method of aspect 10, wherein the packet is received based on a connection (221-2) between the second device and the resource management system being unavailable, a connection (221-1) between the first device and the resource management system being unavailable, or both.

Aspect 12: The method of any of aspects 10 through 11, further comprising: verifying, prior to generating the public key, an identity of the user with the resource management system, wherein the public key is generated based on the identity of the user being verified by the resource management system.

Aspect 13: The method of any of aspects 10 through 12, further comprising: storing, prior to receiving the packet, the public key, the private key, and the identifier of the public key in a cryptographic component (230-2) of the second device.

Aspect 14: The method of any of aspects 10 through 13, further comprising: generating, based on receiving the packet, the secret using the ephemeral key received in the packet and the private key stored at the second device.

Aspect 15: The method of any of aspects 10 through 14, wherein receiving the packet comprises decoding a quick-response code being displayed at the first device.

Aspect 16: The method of any of aspects 10 through 15, wherein a hostname of the first device is obtained based on decrypting the encrypted data, and where the hostname is displayed to the user with the string of randomized characters.

Aspect 17: The method of any of aspects 10 through 16, further comprising: requesting, based on receiving the packet, the user to authenticate an identity of the user using a biometric component (242) of the second device, wherein the string of randomized characters is displayed to the user based on the biometric component authenticating the identity of the user.

Aspect 18: The method of any of aspects 10 through 17, further comprising: receiving, from the resource management system, based on the user requesting access to the first device, a request for the user to verify that the user is requesting access to the first device based on a connection (221-2) between the second device and the resource management system being available and a connection (221-1) between the first device and the resource management system being available; and sending, to the resource management system, a response configured to verify that the user is requesting access to the first device and to trigger the resource management system to send a message to the first device authenticating the user for access to the first device.

Aspect 19: A first device (113-1) comprising one or more memories storing processor-executable code, and one or more processors coupled with the one or more memories and individually or collectively operable to execute the code to cause the first device (113-1) to perform a method of any of aspects 1 through 9.

Aspect 20: A first device (113-1) comprising at least one means for performing a method of any of aspects 1 through 9.

Aspect 21: A non-transitory computer-readable medium storing code the code comprising instructions executable by a processor to perform a method of any of aspects 1 through 9.

Aspect 22: A second device (113-2) comprising one or more memories storing processor-executable code, and one or more processors coupled with the one or more memories and individually or collectively operable to execute the code to cause the second device (113-2) to perform a method of any of aspects 10 through 18.

Aspect 23: A second device (113-2) comprising at least one means for performing a method of any of aspects 10 through 18.

Aspect 24: A non-transitory computer-readable medium storing code the code comprising instructions executable by a processor to perform a method of any of aspects 10 through 18. It should be noted that the methods described above describe possible implementations, and that the operations and the steps may be rearranged or otherwise modified and that other implementations are possible. Furthermore, aspects from two or more of the methods may be combined.

The description herein, provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” as may be used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method at a first device, comprising:
receiving, from a resource management system, a public key of a second device and an identifier of the public key, wherein the public key corresponds to a private key of the second device stored at the second device, is referenceable at the resource management system and the second device using the identifier of the public key, and is associated with a user at the second device and the resource management system;
encrypting, in response to a request to access the first device, a string of randomized characters using a secret generated from an ephemeral key generated at the first device and stored in volatile memory of the first device and the public key, wherein encrypted data is obtained based on encrypting the string of randomized characters;
generating, based on encrypting the string of randomized characters, a packet comprising the ephemeral key, the identifier of the public key, and the encrypted data;
providing, based on generating the packet and in response to the request to access the first device, the packet to the second device for decryption;
receiving, based on sending the packet to the second device for decryption, from the user, an input comprising the string of randomized characters; and
authenticating, based on receiving the input, the user for access to the first device.

2. The method of claim 1, further comprising:
receiving, after receiving the public key from the resource management system and prior to generating the packet, the request to access the first device; and
determining that a connection between the first device and the resource management system is unavailable, a connection between the second device and the resource management system is unavailable, or both, wherein the string of randomized characters is encrypted based on the determining.

3. The method of claim 1, further comprising:
generating, after receiving the public key and in response to the request to access the first device, the ephemeral key; and
generating, based on generating the ephemeral key, the secret from the public key received from the resource management system and the ephemeral key generated at the first device.

4. The method of claim 1, further comprising:
generating, after receiving the public key and in response to the request to access the first device, the string of randomized characters.

5. The method of claim 1, wherein encrypting the string of randomized characters comprises:
encrypting a hostname of the first device is encrypted with the string of randomized characters, wherein the encrypted data is obtained based on encrypting the string of randomized characters and the hostname.

6. The method of claim 1, wherein providing the packet to the second device comprises:
generating a quick-response code that represents a content of the packet; and
displaying, at the first device, the quick-response code.

7. The method of claim 1, wherein the encrypted data is decryptable using the ephemeral key generated by the first device and the private key stored at the second device.

8. The method of claim 1, further comprising:
authenticating, prior to receiving the public key from the resource management system, the user for access to the first device, wherein the public key and the identifier of the public key is received at the first device in response to the user being authenticated for access to the first device via the resource management system.

9. The method of claim 1, further comprising:
communicating wireless signaling with the second device; and
confirming, based on the wireless signaling, that a proximity between the first device and the second device is less than a threshold, wherein the user is authenticated for access to the first device based on the proximity being less than the threshold.

10. A method at a second device, comprising:
generating, for a user of the second device, a public key of the second device and an identifier of the public key, wherein the public key corresponds to a private key of the second device;
registering, by the second device at a resource management system, the public key and the identifier of the public key to the user generated by the second device;
receiving, from a first device, based on the user requesting access to the first device, a packet comprising an ephemeral key generated at the first device, the identifier of the public key, and encrypted data that was encrypted using a secret generated from the public key and the ephemeral key;
decrypting the encrypted data using the private key, wherein a string of randomized characters that provides the user access to the first device is obtained based on decrypting the encrypted data; and
displaying the string of randomized characters for the user to input into the first device.

11. The method of claim 10, wherein the packet is received based on a connection between the second device and the resource management system being unavailable, a connection between the first device and the resource management system being unavailable, or both.

12. The method of claim 10, further comprising:
verifying, prior to generating the public key, an identity of the user with the resource management system, wherein the public key is generated based on the identity of the user being verified by the resource management system.

13. The method of claim 10, further comprising:
storing, prior to receiving the packet, the public key, the private key, and the identifier of the public key in a cryptographic component of the second device.

14. The method of claim 10, further comprising:
generating, based on receiving the packet, the secret using the ephemeral key received in the packet and the private key stored at the second device.

15. The method of claim 10, wherein receiving the packet comprises:
decoding a quick-response code being displayed at the first device.

16. The method of claim 10, wherein a hostname of the first device is obtained based on decrypting the encrypted data, and where the hostname is displayed to the user with the string of randomized characters.

17. The method of claim 10, further comprising:
requesting, based on receiving the packet, the user to authenticate an identity of the user using a biometric component of the second device, wherein the string of randomized characters is displayed to the user based on the biometric component authenticating the identity of the user.

18. The method of claim 10, further comprising:
receiving, from the resource management system, based on the user requesting access to the first device, a request for the user to verify that the user is requesting access to the first device based on a connection between the second device and the resource management system being available and a connection between the first device and the resource management system being available; and
sending, to the resource management system, a response configured to verify that the user is requesting access to the first device and to trigger the resource management system to send a message to the first device authenticating the user for access to the first device.

19. A first device, comprising:
one or more processors; and
one or more memories storing code comprising instructions executable by the one or more processors, individually or collectively, to cause the first device to:
receive, from a resource management system, a public key of a second device and an identifier of the public key, wherein the public key corresponds to a private key of the second device stored at the second device, is referenceable at the resource management system and the second device using the identifier of the public key, and is associated with a user at the second device and the resource management system;
encrypt, in response to a request to access the first device, a string of randomized characters using a secret generated from an ephemeral key generated at the first device and stored in volatile memory of the first device and the public key, wherein encrypted data is obtained based on encrypting the string of randomized characters;
generate, based on encrypting the string of randomized characters, a packet comprising the ephemeral key, the identifier of the public key, and the encrypted data;
provide, based on generating the packet and in response to the request to access the first device, the packet to the second device for decryption;
receive, based on sending the packet to the second device for decryption, from the user, an input comprising the string of randomized characters; and
authenticate, based on receiving the input, the user for access to the first device.

20. The first device of claim 19, wherein the instructions are further executable by the one or more processors, individually or collectively, to cause the first device to:
receive, after receiving the public key from the resource management system and prior to generating the packet, the request to access the first device; and
determine that a connection between the first device and the resource management system is unavailable, a connection between the second device and the resource management system is unavailable, or both, wherein the string of randomized characters is encrypted based on the determining.
